(19) United States
(12) Patent Application Publication
(10) Pub. No.: US 2007/0263878 A1
(43) Pub. Date: Nov. 15, 2007

(54) SOUND MASK AND SOUND BOX

(75) Inventors: Tzu-Cheng Yu, Shenzhen City (CN); Tsung-Lung Yang, Shenzhen City (CN); Kuan-Hong Hsieh, Shenzhen City (CN); Xiao-Guang Li, Shenzhen City (CN)

Correspondence Address: NORTH AMERICA INTELLECTUAL PROPERTY CORPORATION, P.O. BOX 506, MERRIFIELD, VA, 22116, US

(73) Assignee: ENSKY TECHONLOGY (SHENZHEN) CO., LTD., Shenzhen City (CN)

(21) Appl. No.: 11/747,237

(22) Filed: May 11, 2007

(30) Foreign Application Priority Data
May 12, 2006 (CN) 200610060634.1

(51) Int. Cl. H04R 3/02

(52) U.S. Cl. 381/73.1

(57) ABSTRACT

A sound mask is disclosed. The sound mask defines through holes. Rotational axis of the through holes are inclined relative to a surface normal of the sound mask. The sound mask is used in a sound box for obtaining a width sound field and a good distinguishing ability of sound source.

### BACKGROUND

1. Technical Field

The present invention relates to a sound mask and a sound box.

2. General Background

In multi-channel sound system, speakers are fitted in different sound boxes or in a same sound box.

When the speakers are fitted in different sound boxes, the sound boxes should be positioned apart from each other so that sound sources can be distinguished and a wide width of sound field is obtained. But because of a limited space or short wires lengths of the sound boxes, the sound boxes may be unable to be positioned apart sufficiently, thus the sound effects are bad. When the speakers are fitted in a same sound box, the speakers are adjacent to each other so that the sound effects are bad too.

Sound mask is equipped on the sound box for speaker protection and dust prevention, but isn't used for obtaining a width sound field and a good distinguishing ability of sound sources.

Therefore, what is needed is a sound box having a width sound field and a good distinguishing ability of sound sources and a sound mask used in this sound box.

### SUMMARY

A sound mask is disclosed. The sound mask defines through holes. Rotational axis of the through holes are inclined relative to a surface normal of the sound mask. The sound mask is mounted in a sound box. The sound box includes at least one speakers corresponding to the through holes.

Further features and advantages will be provided or will become apparent in the course of the following detailed description.

### BRIEF DESCRIPTION OF THE DRAWINGS

FIG. 1 is a schematic, front view of a sound mask according to a first embodiment of the present invention;

FIG. 2 is a section view of the sound mask of FIG. 1;

FIG. 3 is a schematic view of a sound box with the sound mask of FIG. 1;

FIG. 4 is a schematic, front view of the sound box of FIG. 3, without the sound mask of FIG. 1;

FIGS. 5-7 are sound pressure profiles of the sound box of FIG. 4; and

FIG. 8 is a schematic, isometric view of sound masks according to a second embodiment of the present invention, the sound masks being mounted on sound boxes.

### DETAILED DESCRIPTION OF THE EMBODIMENT

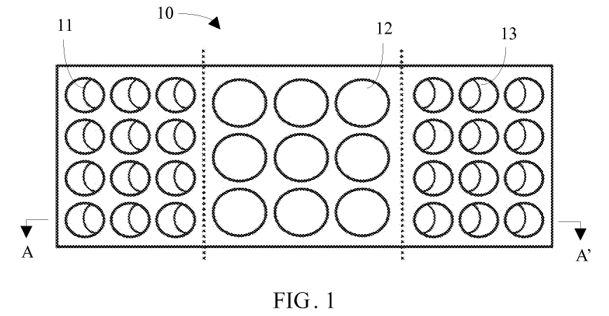

Referring to FIG. 1, a sound mask 10 is disclosed. A front surface of the sound mask 10 defines three sets of through holes 11, 12 and 13. The sets of through holes 11, 13 are inclined holes. The set of through holes 12 are straight holes. A center of axis of each of the straight holes 12 is parallel to a surface normal of the front surface.

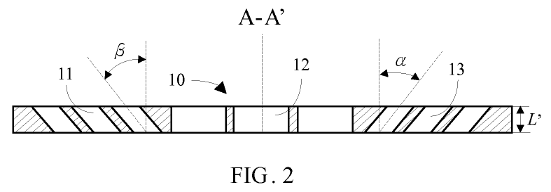

Referring to FIG. 2, a thickness of the sound mask 10 is denoted by L. A rotational axis of each of the through holes 13 is at a positive angle α relative to the surface normal of the sound mask 10. A rotational axis of each of the through holes 11 is at a negative angle β relative to the surface normal of the sound mask 10. An absolute value of the angle α is equal to that of the angle β.

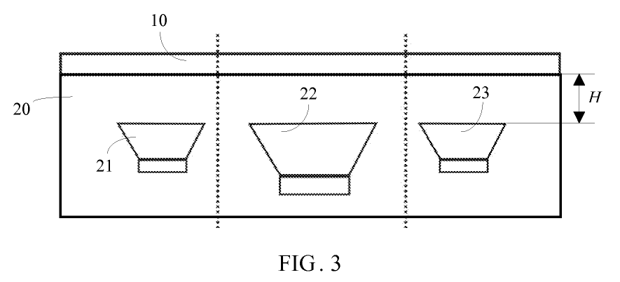

Referring to FIG. 3, the sound mask 10 is mounted on a sound box 20. The sound box 20 includes speakers 21, 22, and 23. The speakers 21, 22, and 23 are configured under the through holes 11, 12, and 13 respectively. A distance between the speakers 21, 22, 23 and the sound mask 10 is denoted by H.

Sounds produced by different speakers 21, 22, 23 are resonated in different directions relatively because the rotational axis of the through holes 11, 12, 13 radiates. As a result, a sound field of the sound box is wide. Sound echoed from different speakers can be distinguished.

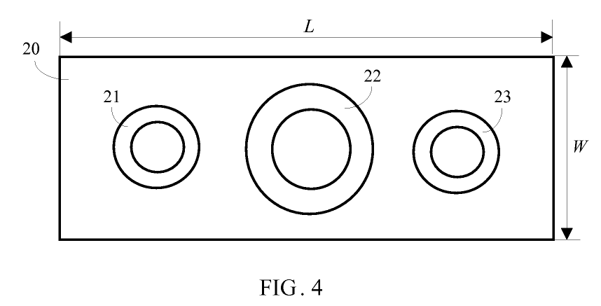

Referring to FIG. 4, a length of the sound box 20 is denoted by L, and a width of the sound box 20 is denoted by W.

Values of L, W, and H are dependent on what kind of the sound box is. That is, different sound boxes may have different L, W, H. In this embodiment, the value of L is 0.43 (meter), the value of W is 0.17 (meter), and the value of H is 0.005 (meter). It should be noted that the ratio as shown in the drawing such as FIGS. 2 to 4 is not corresponding to the real data thereof, only for illustrating purpose.

In general, it is known that sound effect of the sound box 20 is dependent on a resonant frequency, and the resonant frequency is further dependent on structure dimensions of the sound box 20 (i.e., a resonant chamber) and the sound mask 10 (i.e., an opening of the resonant chamber). Therefore, the sound effect of the sound box 20 is determined by the sizes of the sound box 20 and the sound mask 10. If the values of L, W, and H is definite, the sound effect of the sound box 20 is determined by the values of L′, α, and β (an area ratio of the through holes 11, 12, 13 to the sound mask 10). In this embodiment, the value of L is 0.01 meter, the absolute value of α and β is 50 degree.

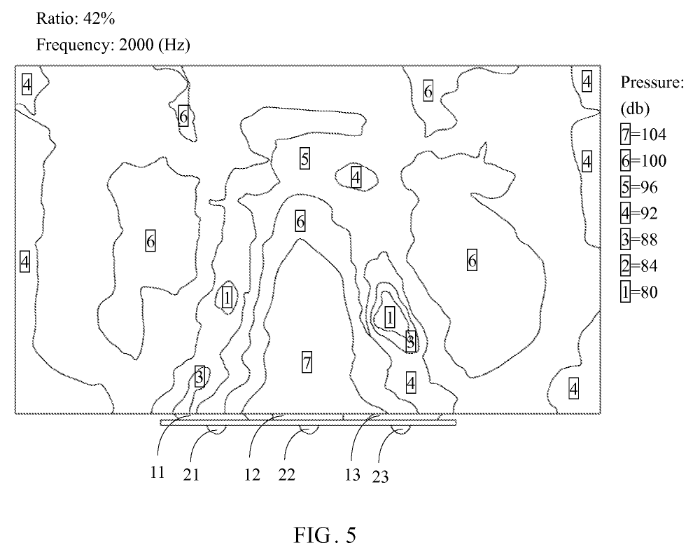

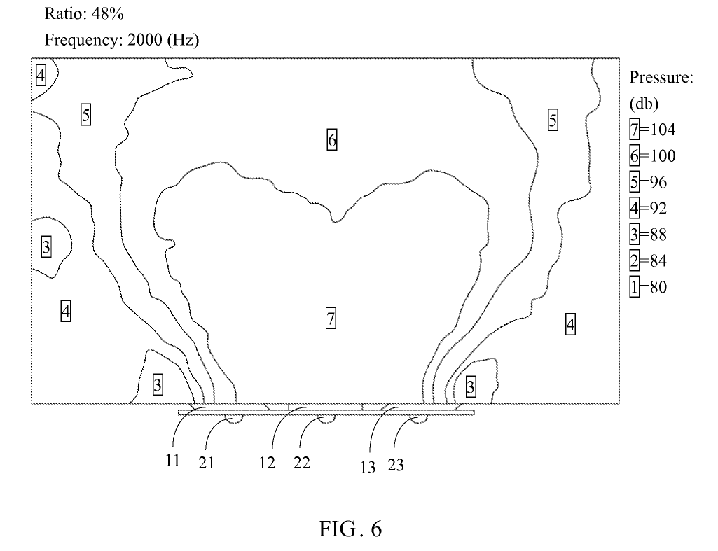

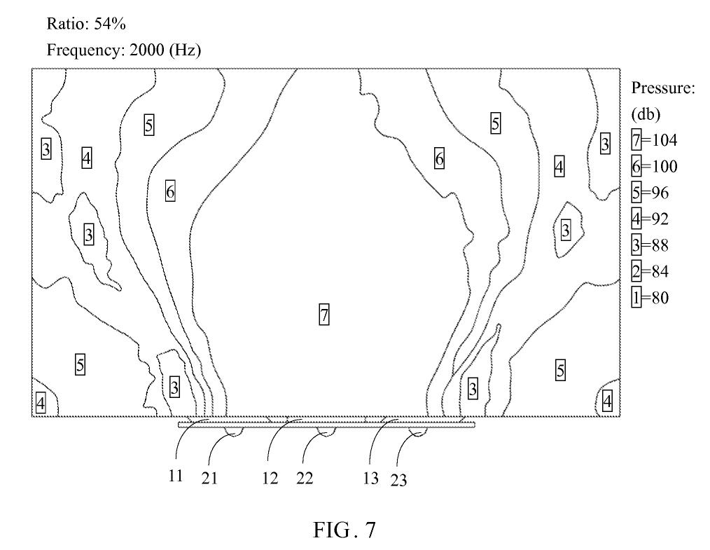

Referring to FIGS. 5 to 7, sound pressure profiles of the sound box 20 are shown. A distribution frequency of the speakers 21, 22, and 23 is 2000 Hertz. The absolute value of α and β is 50 degree. The value of R for three kinds of area ratio is 0.42, 0.48, and 0.54 respectively. It can be obtained from FIGS. 5 to 7 that when the range of R is 0.42 to 0.54, the distribution of sound pressure is even, when R is equal to 0.48, the distribution of sound pressure is most even.

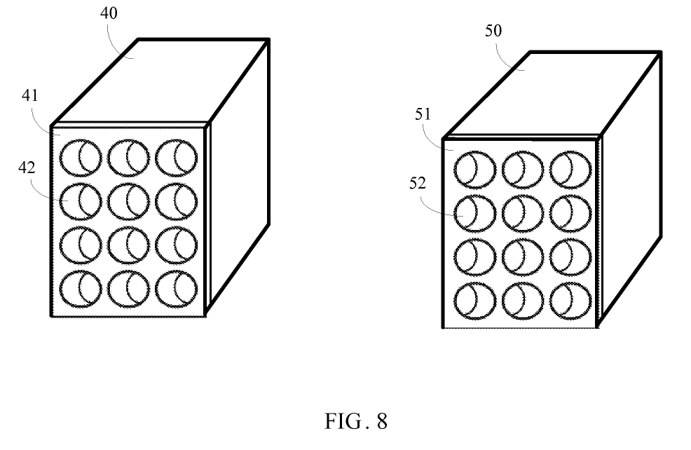

Referring to FIG. 8, two sound masks 41, 51 in accordance with a second embodiment of the present invention are shown. The sound mask 41 defines a set of through holes 42. The through holes 42 are at a negative angle relative to a surface normal of the sound mask 41. The sound mask 51 defines a set of through holes 52. The through holes 52 are at a positive angle relative to the surface normal of the sound mask 51. The sound masks 41, 51 are mounted on sound boxes 40, 50 respectively. A good sound effect can be obtained even if the sound boxes 40, 50 are near to each other.

Moreover, it is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A sound mask comprising:
a plurality of through holes, wherein rotational axis of the through holes are inclined relative to a surface normal of the sound mask.

2. The sound mask of claim 1, wherein the through holes comprise a first set of through holes and a second set of through holes, rotational axis of each of the first set of through holes is at an positive angle relative to the surface normal, rotational axis of each of the second set of through holes is at an negative angle relative to the surface normal.

3. The sound mask of claim 2, further comprising a third set of through holes, the axis of each of the third set of through holes is parallel to the surface normal.

4. The sound mask of claim 2, wherein absolute values of the positive angle and the negative angle are identical to each other.

5. The sound mask of claim 4, wherein absolute values of the positive angle and the negative angle are 50 degree.

6. The sound mask of claim 3, wherein a range of a ratio of an area of the straight through holes and the inclined through holes to an area of the sound mask is 0.42 to 0.54.

7. The sound mask of claim 6, wherein the ratio is 0.48.

8. A sound box comprising:
at least one speaker;
a sound mask mounted on the sound box comprising a plurality of through holes, wherein rotational axis of the through holes are inclined relative to a surface normal of the sound mask.

9. The sound box of claim 8, wherein the inclined through holes comprise a first set of through holes and a second set of through holes, rotational axis of each of the first set of through holes is at an positive angle relative to the surface normal, rotational axis of each of the second set of through holes is at an negative angle relative to the surface normal.

10. The sound box of claim 9, wherein the sound mask further comprises a third set of through holes, axis of each of the third set of through holes is parallel to the surface normal.

11. The sound box of claim 9, wherein absolute values of the positive angle and the negative angle are identical to each other.

12. The sound box of claim 11, wherein absolute values of the positive angle and the negative angle are 50 degree.

13. The sound box of claim 10, wherein a range of a ratio of an area of the straight through holes and the inclined through holes to an area of the sound mask is 0.42 to 0.54.

14. The sound box of claim 13, wherein the ratio is 0.48.
